(19) United States
(12) Patent Application Publication
(10) Pub. No.: US 2006/0149824 A1
(43) Pub. Date: Jul. 6, 2006

(54) Terminal data format and a communication control system and method using the terminal data format

(75) Inventors: Jae-Seok Park, Seoul (KR); Hyun-Sik Shim, Yongin-si (KR); Hye-Jong Kim, Incheon (KR); Bo-Hyun Kang, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd, Suwon-si (KR)

(21) Appl. No.: 11/323,775

(22) Filed: Dec. 30, 2005

(30) Foreign Application Priority Data
Dec. 30, 2004 (KR) 116792/2004
Dec. 12, 2005 (KR) 122044/2005

(51) Int. Cl. G06F 15/16

(52) U.S. Cl. 709/206

(57) ABSTRACT

A terminal data format capable of efficiently controlling various network-based robots in a ubiquitous robotic companion (URC)-based infrastructure, a communication control system using the terminal data format, and a method thereof are provided. The data format includes a Protocol Discriminator field including information on a protocol identifier (ID) in order to permit interfacing between a robot, a server, and a client; a Session ID field for identifying a currently connected session; a Profile ID field for identifying a profile performed by any one of the robot, the server, and the client; an MSG Type field including information on types of messages transceived between the robot, the server, and the client; and a Payload field for performing a service for a corresponding function according to data defined in the MSG Type field and the profile information included in the Profile ID field.

### CLAIM OF PRIORITY

This application makes reference to, incorporates herein, and claims all benefits accruing under 35 U.S.C. § 119 from applications entitled TERMINAL DATA FORMAT, COMMUNICATION CONTROL SYSTEM USING THE TERMINAL DATA FORMAT, AND METHOD THEREOF, which were filed in the Korean Intellectual Property Office on Dec. 30, 2004 and Dec. 12, 2005, and assigned Serial No. 10-2004-0116792 and 10-2005-0122044, respectively.

### BACKGROUND OF THE INVENTION

1. Field of the Invention

The present invention relates generally to a terminal data format, a communication control system using the terminal data format, and a method thereof, and more specifically, to a terminal data format capable of efficiently controlling various network-based robots in a ubiquitous robotic companion (URC)-based infrastructure and making development based on service extension useful, a communication control system using the terminal data format, and a method thereof.

2. Description of the Related Art

Generally, robots are equipped with various sensors and can perform tasks, which are commanded by a user, by executing programs based on recognizable instructions such as vocal or written instructions. As such, robots have gradually developed into human robots, such as cleaning robots, doll robots, etc., according to tasks given to them. Furthermore, each robot has been developed to perform various functions at the same time.

Additionally, such robots have been developed to provide various services through communication with humans. For this communication, many groups and academic societies have proposed a method and architecture of setting up robot interfaces using the Internet, open network. One of recent proposals, the architecture of a proxy-mediated human-robot interface (HRI), includes the communication between user interface agents (IAs) and embedded agents (EAs) using a proxy-mediated human robot interface through the Internet.

FIG. 1 illustrates networking in a conventional architecture of a proxy-mediated human-robot interface. Referring to FIG. 1, a proxy agent reduces the communication load of an IA and a percentage of resources computed by the EA for tasks related to the interface. Further, the proxy agent dynamically generates or removes a link between the IA and the EA, and asynchronously transmits upstream data.

In FIG. 1, RoboML is used, which is a Markup language for robots, i.e., a modified XML. XML is used for agent communication and information expression because of suitability that it can be expressed by well-known languages to make a program, convenience that it can be easily processed or operated by a user, and compatibility that it can be used for application programs in other platforms.

The agent communication languages include AOP (Agent-Oriented Programming) with which agents can be programmed to communicate and evolve, Telescript that defines an environment for transactions between software applications over a network, KQML (Knowledge Query Manipulation Language), FIPA (Foundation for Intelligent Physical Agents), etc.

The robot languages include TCA (Task Control Architecture) that combines Task-Level Control and communication and transfers a message between processors to achieve concurrency, PRS (Procedure Reasoning System) that is based on the concept of a procedure reasoning expert, GOLOG that is a logic-based action language developed to program navigation for movement, manipulation, perception, and interaction, etc.

As such, programmed robot languages can convey user commands using a transmission protocol that can be interfaced in order to control the robots remotely. The construction and action of an arbitrary robot can be defined through a framework definition, and the robot can be used for robot data communication using existing communication protocol.

However, because the robot manufacturer customizes a transmission protocol for robots, it is difficult to apply the protocol to other robots. As a result, it is nearly impossible to interwork between the robot and the server.

Further, the existing transmission protocol for robots cannot be uniformly applied to a plurality of robots. Therefore, the transmission protocol shows a low general-purpose characteristic, and a low development prospect resulting from lack of compatibility.

### SUMMARY OF THE INVENTION

It is, therefore, an object of the present invention to provide a communication protocol between a robot, a URC server, and a remote client, to enable various robots based on a URC to provide a user with services that are intelligent, active, and suitable for situation through a URC-based infrastructure, and a communication control system and method capable of smoothly controlling the robots using such a communication protocol.

It is another object of the present invention to provide a communication control system and method, in which service providers (or remote clients) control the robots at a remote position using the communication protocol, thereby improving flexibility in developing the services.

According to an aspect of the present invention, there is provided a data format for transmitting data between a terminal and a server. The data format includes: a Protocol Discriminator field for permitting interfacing between the terminal and the server; a Session ID field for setting up an ID to identify the terminal; a Data Direction field for setting up a direction to transmit the data between the terminal and the server; a Data Type field for representatively defining at least one of the format and content of the data; a Service ID field for determining if a message service to be performed by at least one of the terminal and the server is used, and setting up an ID to identify the determination; and a Payload field for setting up the data defined in the Data Type field and an available service determined in the Service ID field, and assigning a message to enable the terminal and the server to use the service.

According to another aspect of the present invention, there is provided a communication control system using a data format for a terminal. The communication control system includes: a terminal for performing at least one service for video, audio, and movement according to Payload contents of the data format; and a server for recognizing user commands through the terminal to transmit and receive the data format to and from the terminal according to corresponding protocol, and controlling to perform the service with the data format.

According to yet another aspect of the present invention, there is provided a method of transmitting a terminal data format between at least one terminal and a server using a corresponding protocol. The method includes the steps of: confirming an authorization between the terminal and the server using the data format according to an authorization procedure; assigning a Session ID to identify each of the terminals using the data format after the authorization; inputting a voice command of a user to a corresponding terminal assigned the Session ID; transmitting a Payload message of the data format having voice data to the server; analyzing the Payload message in order to call back to the Service ID; and transmitting, by the corresponding terminal performing an operation according to the Service ID, the result to the server as a Payload message of the packet.

According to yet another aspect of the present invention, there is provided a data format for a terminal, in which the data format is transceived between a robot, a server, and a client in order to control the robot. The data format includes: a Protocol Discriminator field including information on a protocol identifier in order to permit interfacing between the robot, the server, and the client; a Session ID field including unique information (ID) for identifying a currently connected session; a Profile ID field including information for identifying a profile (control function) performed by any one of the robot, the server, and the client; an MSG Type field including information on types of messages transceived between the robot, the server, and the client; and a Payload field including the message for performing a service for a corresponding function according to data defined in the MSG Type field and the profile information included in the Profile ID field.

According to yet another aspect of the present invention, there is provided a communication control system, which includes: a robot for performing at least one for video, audio, and movement services according to a content of Payload of a previously set data format; a server for recognizing a command of a user through the robot, transceiving the data format with respect to the robot according to a corresponding protocol, and controlling to perform the service with the data format; and a client for performing a remote control and monitoring service of the robot through the server at a remote position.

According to yet anther aspect of the present invention, there is provided a method of controlling at least one robot using at least one remote client in a communication control system having the client, the robot, and a server providing an interface between the client and robot. The method includes the steps of: providing, by the remote client, connection to the server in order to perform a service for remote control and monitoring of any one of the robots; requesting authentication and information on a list of the plurality of robots connected to the server; performing, by the server, the authentication of the client, and transmitting the list information of the robots connected with the server to the client; selecting, by the client, the robot to be controlled using the robot list information transmitted from the server; transmitting the corresponding information to the server; and setting, by the server, an interface between the robot selected by the client and the client in order to transceive a message for the robot remote control and monitoring service.

### BRIEF DESCRIPTION OF THE DRAWINGS

A more complete appreciation of the invention, and many of the attendant advantages thereof, will be readily apparent by reference to the following detailed description when considered in conjunction with the accompanying drawings, in which like reference symbols indicate the same or similar components, wherein:

FIG. 1 illustrates network interfacing between a robot and a user host in order to control the robot in accordance with a prior art.

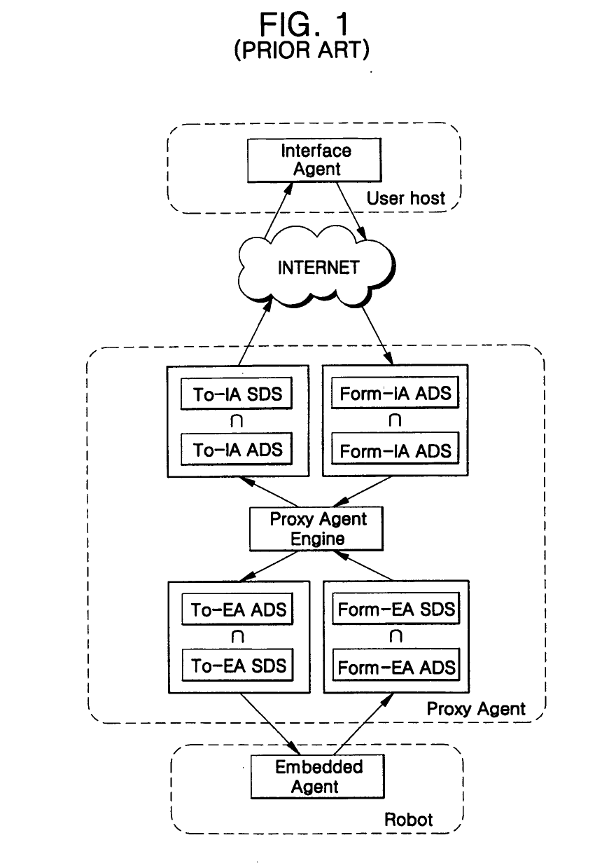

FIG. 2 illustrates a physical architecture of a URC protocol for controlling a robot in accordance with the present invention;

FIG. 3 illustrates the header format of a packet transceived between a robot and a URC server through a URC protocol for controlling the robot in accordance with an embodiment of the present invention;

FIG. 4 is a diagram illustrating a message type variation according to message transceived between a robot and a URC server in accordance with the present invention;

FIG. 5 illustrates network connection of a robot control system using a URC protocol according to an embodiment of the present invention;

FIG. 6 illustrates a sequence of messages transceived for the services, which a URC server can provide to a robot and a client when the robot and client are connected to the URC server in a robot control system according to the present invention;

FIG. 7 illustrates a sequence of messages between a robot and a URC server for a speech recognition service of the robot in a robot control method according to the present invention;

FIG. 8 illustrates a sequence of messages transceived between a robot and a URC server for an image recognition service and a motion detecting (tracing) service in a robot control method according to the present invention;

FIG. 9 illustrates a sequence of messages transceived between a robot and a URC server for authorization of the robot in a robot control method according to the present invention;

FIG. 10 illustrates a sequence of authorization messages transceived between a remote robot and a server for remote monitoring of the robot in a robot control method according to the present invention;

FIG. 11 illustrates types of messages transceived between a robot and a URC server in order to control the robot in a robot control method according to the present invention;

FIG. 12 illustrates types of messages transceived between a remote client and a URC server in order to control the robot through the URC server at the remote client in a robot control method according to the present invention;

FIG. 13 is a schematic illustrating a connection of a robot control system according to an embodiment of the present invention;

FIG. 14 illustrates the format of a common header of messages transceived between a robot, a URC server, and a client according to an embodiment of the present invention;

FIG. 15 illustrates a URC protocol profile architecture between a robot, a client, and a URC server according to an embodiment of the present invention;

FIG. 16 illustrates an ACK operation when an event is generated at a robot in a communication control system according to an embodiment of the present invention;

FIG. 17 illustrates a method of checking a connection between the URC robots and the URC server in a communication control system according to the present invention; and

FIG. 18 illustrates a sequence of messages transceived to remotely control a robot at a client according to an embodiment of the present invention.

### DETAILED DESCRIPTION OF THE PREFERRED EMBODIMENTS

Hereinafter, a terminal data format, a communication control system using the terminal data format, and a method thereof, in accordance with the present invention, will be described in detail with reference to the accompanying drawings.

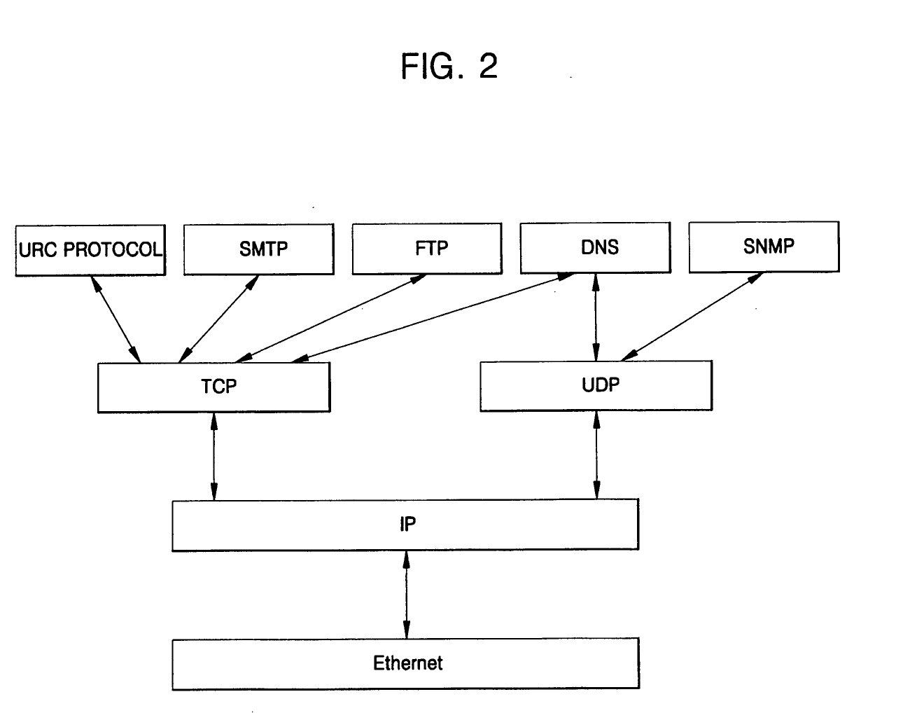

FIG. 2 illustrates a physical layer architecture of a TCP/IP-based URC protocol for controlling robots in accordance with the present invention. As illustrated in FIG. 2, a URC protocol belongs to an application layer on top of TCP/IP layers, network and transport layers, on the basis of Ethernet, verifies if the server is authenticated to use a terminal, i.e. client, and a robot on the basis of TCP/IP, and accordingly controls the server with desired service commands so as to enable the robot to perform desired operation by the verified client. Here, other protocols, such as SMTP (Simple Mail Transfer Protocol), DNS (Domain Name System) etc., have no relation to the technical idea of the present invention, and thus their description is omitted.

The URC protocol, based on an embedded network to manage and operate the robot efficiently, makes it possible to easily interwork between a URC server and the robot, and between a URC server and the client or another terminal, and also simply implement various service operations. The URC protocol also makes it possible to control the robot at the client by tranceiving data between the robot and the URC server, and between the URC server and client through communication between application layers based on the TCP/IP, and also smoothly implement the service operations of the robot by enabling a user to directly input commands through the robot.

It is possible to smoothly implement services desired by a user by protocol matching, interface synchronizing, and data tranceiving between the robot and the URC server, and between the URC server and the client. The tranceived data has a data format used to interface between the robot and the URC server, and between the URC server and the client.

While the data format has a predetermined rule for communication between the robot, the URC server and the URC client, it is referred to as a “packet” in the following description because it complies with a general packet rule.

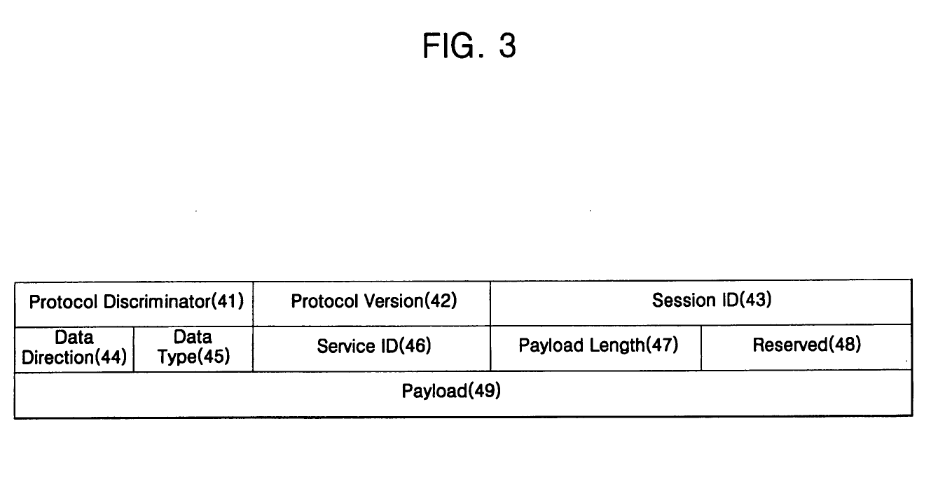

FIG. 3 illustrates a header format of a packet transceived between a robot and a URC server through a URC protocol for controlling the robot in accordance with the present invention. More specifically, packets having a format as illustrated in FIG. 3 are classified into packets for video, audio, VoIP, movement, etc., according to a payload. Corresponding ports transmit these packets. The packets have a common header for the ports.

The common header of the packet has a plurality of fields, i.e., Protocol Discriminator 41, Protocol Version 42, Session ID 43, Data Direction 44, Data Type 45, Service ID 46, Payload Length 47, Reserved 48, and Payload 49. Here, the Payload 49 contains a Payload Head of 2 bytes, and has an internal field made up of Client Type, Client ID, User ID, Message Type, and Authorization Code.

The Protocol Discriminator 41 is assigned 2 bytes, which is a first field value used to designate that message data is a message defined in the protocol. Only when input data has the same Protocol Discriminator, namely the same first field value, the data is processed after interfacing is authorized. However, if the interfacing is not authorized, the data is discarded instead of being processed. For example, the Protocol Discriminator has a format of 0x7E7E.

The Protocol Version 42 is assigned 2 bytes, representing the version of the protocol. The Protocol Version 42 is initially set to 0x0001 (Version 1.0), which is increased by one whenever the protocol is updated.

The Session ID 43 is assigned 4 bytes, and formed of the session number that is initially set to 0x00000000. The Session ID 43 is automatically assigned to the robot by the server after authentication of the user is completed, and is used to individually discriminate and identify the robot from other terminals (e.g., user terminals and PDAs). For example, there are methods of using one port or several ports. When using one port, the port is used to identify the robot from the other robots. However, when using several ports, the ports are used to identify the respective ports, as well as differentiate the robot from the other robots.

In the following description, the Session ID 43 will be described for the purpose of identifying the robot using one port.

The Data Direction 44 is a field that is assigned 1 byte, and identifies the final destination of the data. More specifically, the Data Direction 44 is used to determine if the data is sent from the robot to the URC server, or from the client to the URC server. Therefore, the Data Direction 44 is used to identify which entity sends the data. For example, when 0x01 appears in the Data Direction 44 field, this means that the data is sent from the robot to the URC server.

The Data Type 45, which is assigned 1 byte, has various types according to the format and content of the data. For example, the various types may include ASR (Automatic Voice recognition) denoting data for speech recognition, TTS (Text To Speech) denoting data for voice output, FR (Face Recognition)/MD (Motion Detection) denoting to data for face recognition and motion detection, Authorization denoting data for authorization, data for robot control, data for PDA, data for VoIP, etc. The data can be transferred from different ports in accordance with the data format of the Data Type 45.

The Service ID 46, which is assigned 2 bytes, is an ID assigned by the URC server in order to identify service sessions of the robot and the remote client. The Service ID 46 is used to determine if the Payload services can be used, and to identify the determined results. There are various services according to a value of the Service ID field, which are divided into an unmanned security service, a remote monitoring service, a speech recognition service, and a video recognition service. The Service ID initially starts with 0x0000, and then is increased by one whenever the service starts.

The Payload Length 47 has 2 bytes, and indicates the actual size in byte of the payload except for the header.

The Reserved 48 is an unused extra field that has 4 bytes, and that is not used as an additional field item to guarantee QoS (Quality of Service) of the packet in the future.

The Payload 49 is a part into which an additional field for API (Application Programming Interface) corresponding to each service is included together with actual video and audio data. It is necessary to additionally differentiate messages that are transmitted to the port after the common header is defined. The Payload is transmitted with the data of the type as defined in the Data Type 45, such as ASR as data for speech recognition, TTS as data for voice output (combination), FR/MD as data for face recognition and motion detection, Authorization as data for authorization, data for robot control, data for PDA, data for VoIP, etc.

Although not shown, the Payload 49 can be divided into a number of messages indicating the ASR as data for speech recognition, TTS as data for voice output (combination), FR/MD as data for face recognition and motion detection, Authorization as data for authorization, data for robot control, data for PDA, and data for VoIP. Accordingly, the Payload 49 additionally includes fields for Client Type, Client ID, User ID, Authorization Code, and Message Type.

The Client Type is assigned 1 byte, and denotes a type of terminal. For example, the robots or the remote client terminals are indicated by 0x01, 0x02, 0x03, and 0x04, respectively. That is, if the client terminal is either a source or a destination according to the data transmission direction indicated by the Data Direction 44, the Client Type indicates that client terminal.

The Client ID is assigned 4 bytes and is used to identify client terminals by assigning unique IDs to the client terminals. In order to assign the ID, an order of production, a district of a user, an ID of the user, etc., are combined to generate a proper ID

The User ID is assigned 1 byte, and denotes an ID recognized by the URC server. The User ID is initially set to 000000, and then increased by one whenever the number of users increases. The ID to be registered is assigned to the user after being authorized by the URC server. In the case of a plurality of users, the others, excluding one as a master, are slaves.

The Authorization Code is a field including the authorization number of an authorization message for the robot, and has a default value when the Message Type field of a message head part does not indicate the authorization message. When the Message Type field of the message head part indicates the authorization message, an authorization key provided to an individual in advance is input by the user, and the services can be provided only if authorization is confirmed.

The Message Type is assigned 2 bytes and is used to differentiate between procedures according to whether it is to transmit data, or to perform connection initialization, response, synchronization, authorization, etc., between the robot and client and URC server.

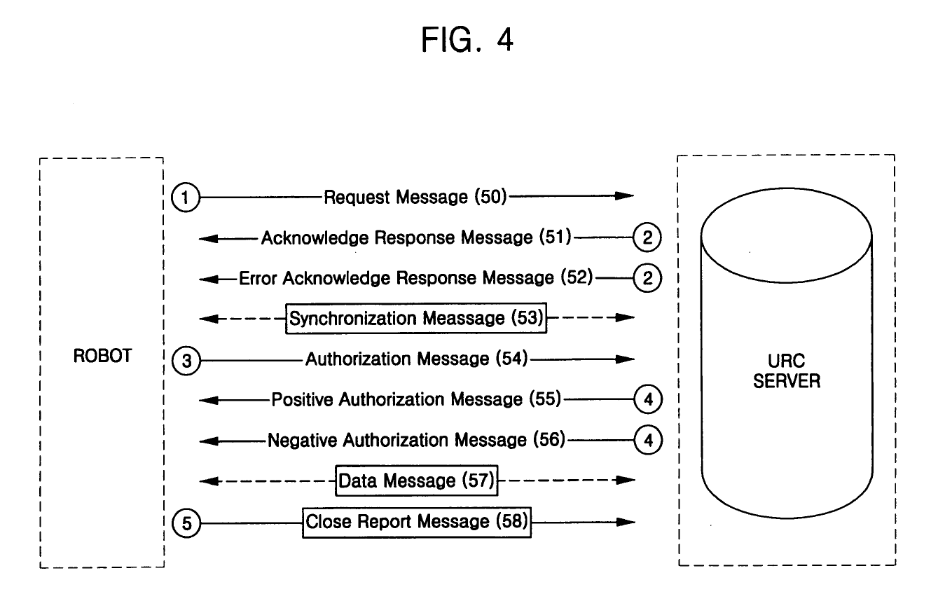

FIG. 4 is a diagram illustrating variation in Message Type transceived between a robot and a URC server in accordance with the present invention. Referring to FIG. 4, when differentiating between procedures according to the message type, there are request message 50, acknowledgement response message 51, error acknowledgement response message 52, synchronization message 53, authorization message 54, positive authorization message 55, negative authorization message 56, data message 57, and close report message 58.

As illustrated in FIG. 4, a request message 50 is a message transmitted to the URC server when the robot tries to connect to the URC server. An acknowledge response message 51 is a message transmitted from the URC server to the robot when the robot transmits the request message 50 to make a request for connection, and thus being successfully connected with the URC server. An error acknowledgement response message 52 is a message transmitted from the URC server to the robot when the robot does not succeed in connecting with the URC server. A synchronization message 53 is a message used to check if the connection between the URC server and the robot is continuously maintained after the connection between the URC server and the robot is completed. An authorization message 54 is used to request authorization of the robot from the URC server when a message, an acknowledge response message 52, indicating that the network connection with the robot is normal, is received from the URC server.

A positive authorization message 55 is a message transmitted to the robot when the URC server succeeds in authorization of the robot. A negative authorization message 56 is a message transmitted to the robot when the URC server does not succeed in authorization of the robot. A data message 57 is a message used in video, audio, TTS, VoIP, and control data transmission in the corresponding format when general data are transferred. A close report message 58 is a disconnection message transmitted from the robot to the URC server when the user gives the robot a command to terminate the connection with the URC.

The payload messages are divided into one for video, one for audio, and one for movement. The payload message field for video includes a file number portion, a size indication portion, and a real binary data portion. The file number consists of 1 byte for a Client Type, 4 bytes for a Client ID, and 3 bytes for a File Generation Sequence. The size consists of 4 bytes, and indicates the size of a real video. The data is real data.

The payload message field for audio has the same form as the one for video. Therefore, the payload message field for audio includes a file number portion, a size indication portion, and a real binary data portion. The file number consists of 1 byte for a Client Type, 4 bytes for a Client ID, and 3 bytes for a File Generation Sequence. The size consists of 4 bytes, which indicates the size of a real voice. The data is real data.

For example, if the payload message fields for video and audio have the file number 0x01 (Client Type) 000000001 (Client ID) 000009 (File Generation Sequence), this means audio and video data generated from a first robot for the ninth time. If a value of the Data Direction at the head is 0x01, it means that the audio and video data are to be transmitted from the camera and microphone of the robot to the server. If the value of the Data Direction is 0x02, it means that the audio and video data are to be transmitted in the opposite direction.

The payload message field for movement includes five command types according to the type of a control command, i.e., a robot movement, a robot status control, a robot status report, a robot error status, and a camera control. If the command type is the robot movement, it is assigned a total of 12 bytes, i.e., 4 bytes for an X axial movement distance of the robot, 4 bytes for a Y axial movement distance of the robot, 2 bytes for a position angle of the robot, and 2 bytes for a camera angle. The distance and angle are in millimeter and degree, respectively.

If the command type is the robot status control, it is assigned a total of 5 bytes, i.e., 1 byte indicating if a report is made on a robot status, and 4 bytes for a period of the report.

If the command type is the robot status report, it is assigned a total of 15 bytes, i.e., 12 bytes for information on a current position of the robot using information on the robot movement, 2 bytes for information on a current status of the robot, and 1 byte indicating if an action is completed. Here, the current status is one of an unmanned security setup status, a robot movement status, a monitoring status, a robot abnormal status, an identification confirmation status, and an alarm status.

If the command type is the robot error status, it is assigned a total of 3 bytes, and has a result of the robot determining if the robot is abnormal for itself. The result is given as a message of “no problem,” “robot movement unit failure,” “movement restriction resulting from obstacle,” and “insufficient battery.”

If the command type is the camera control, it is assigned a total of 2 bytes, i.e., 1 byte for a commanded state related to a video data transmission start etc., and 1 byte for video data transmission.

The following description will be made about a robot control system using the above-mentioned data format according to the present invention.

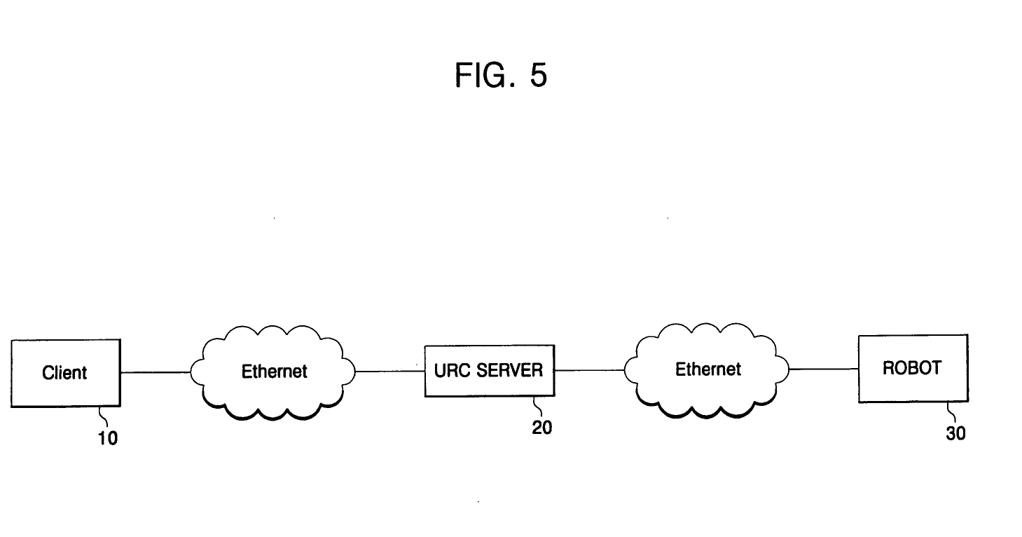

FIG. 5 illustrates network connection of a robot control system using a data format according to the present invention. As illustrated in FIG. 5, a robot control system includes a client 10, a URC server 20, and a robot 30. The client 10 and the URC server 20, and the URC server 20 and the robot 30 are connected to each other through networks based on the TCP/IP, e.g., an Ethernet, and transmit and receive packets to perform operations according to speech recognition data, image recognition data, and control data for movement.

When a user transfers a control packet through the network in order to operate the robot 30 via the client 10, the URC server 20 parses a payload of the received packet.

When a command of the user is a voice or keyboard command, the URC server 20 controls the robot 30 to perform the service corresponding to the command.

Thereafter, the robot 30 completes the service, and provides the URC server 20 with a packet corresponding to the service. The URC server 20 parses the service completion packet received from the robot 30, and provides the client 10, which has made a request for the service, with a result message corresponding to the parsing through the network.

Accordingly, the client 10 displays the result message received from the URC server 20 in order to enable the user to perform monitoring.

When the user inputs a service command in voice into the robot 30, the robot 30 converts a voice input signal input by the user into a TCP/IP packet, and transmits the converted TCP/IP packet to the URC server 20. The URC server 20 parses audio data of the packet received from the robot 30, and recognizes a service requested by the user. The URC server 20 converts the packet with the audio data into a packet for a movement control command, and transmits the converted packet to the robot 30 through the network. The robot 30 performs a service corresponding to a payload of the packet received from the URC server 20. When the robot 30 transmits a response to the service to the URC server 20, the URC server 20 creates a result of the transmitted response into a voice packet, and transmits the voice packet to the robot 30. Accordingly, the user can confirm the result through a voice message output from the robot 30.

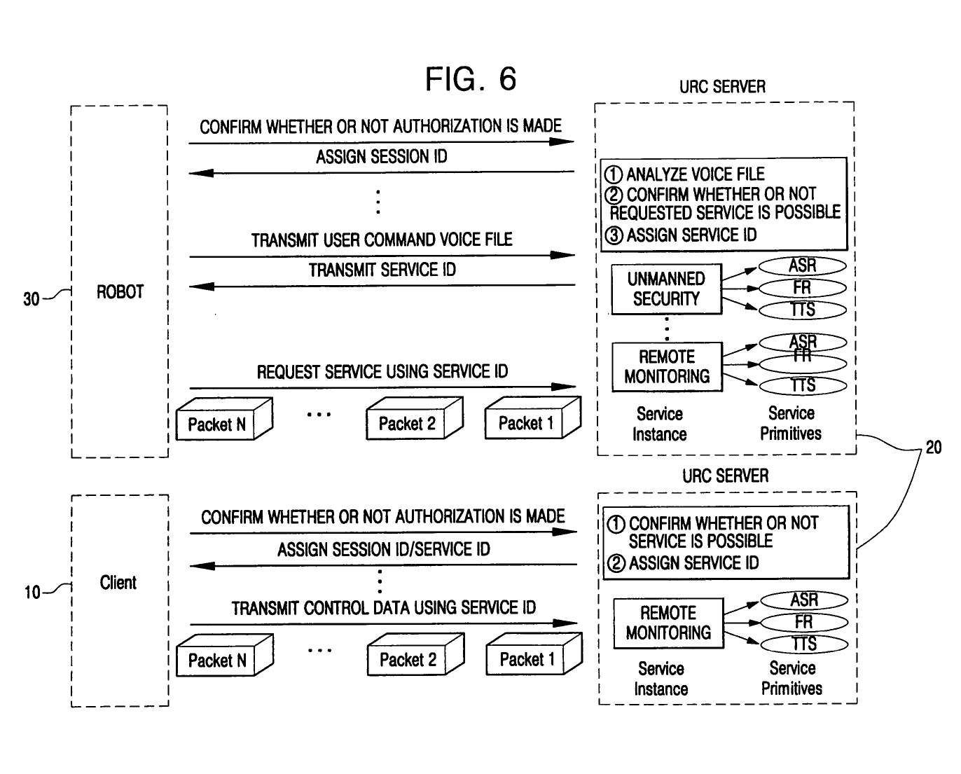

FIG. 6 illustrates services that a URC server can provide to a robot and a client, as well as a process of transceiving basic messages for the services when the robot and client are connected to the URC server in a robot control system according to the present invention. Again, the packet includes various fields, i.e., Protocol Discriminator 41, Protocol Version 42, Session ID 43, Data Direction 44, Data Type 45, Service ID 46, Payload Length 47, Reserved 48, and Payload 49. In particular, the Payload 49 field has internal fields: Client Type, Client ID, User ID, Authorization Code, and Message Type.

As illustrated in FIG. 6, both the robot 30 and the client 10 can perform the service requested by the user, only when they are authorized at the URC server 20. First of all, data for authorization is set for the Authorization Code and Message Type among the internal fields of the Payload field of the packet, and the authorization procedure is performed according to each of the code and message.

More specifically, the robot 30 is not initially authorized, and thus transmits a connection request message for authorization to the URC server 20. The message transmitted from the robot 30 to the URC server 20 has an authorization number that is set as a default for the Authorization Code. Further, the Message Type of the Payload has a Request Message in order to attempt interconnection, and data according to initial connection are set for the other fields excluding the Request Message.

The URC server 20 receiving the connection request message confirms that the Message Type of the Payload is the Request Message, and transmits a response message—Acknowledge Response Message—indicating that connection is successful to the robot 30. When the connection is not successful, the URC server 20 transmits the packet having the Error Acknowledge Response Message to the robot 30. When the Message Type of the Payload of the transceived message indicates the Synchronization Message, the network connection is continuously performed between the URC server 20 and the robot 30.

The URC server 20 determines the network to be normal, and transmits the Acknowledgement Response Message to the robot 30. The robot 30 receiving the Acknowledgement Response Message recognizes the connection to be successful, and transmits an Authorization Message, which indicates a request for authorization through the Message Type of the Payload of the received message, to the URC server 20.

Thereafter, the URC server 20 performs the authorization on the robot 30 according to the authorization request of the robot 30. When the authorization is successful, the URC server 20 transmits a Positive Authorization Message indicating success of the authorization to the robot 30. The transmitted message contains information on the authorization number of the robot 30, and thus the authorization number is allotted to the robot 30. If the authorization of the robot 30 ends in failure due to internal or external factors, the URC server 20 transmits a Negative Authorization Message indicating failure of the authorization to the robot 30.

Accordingly, it is possible to perform services for video, audio, movement, etc., which are desired by a user, by transceiving an arbitrary service request packet between the URC server 20 and the robot 30, after it is confirmed if authorization between the URC server 20 and the robot 30 is successful.

An authorization procedure of the client 10 is the same as the above-described authorization procedure of the robot 30. Therefore, the authorization procedure of the client 10 is no longer described. Further, it is assumed that authorization of the client 10 be completed through the same procedure as the authorization procedure of the robot 30.

When the authorization procedure is completed with respect to the robot 30 and the client 10, the URC server 20 assigns an ID to a Session ID field in order to differentiate between at least one client 10 and the URC server 20 and between the URC server 20 and at least one robot 30, and then transmits the packet to the robot 30 and the client 10. The corresponding robot 30 and client 10 make a request to the URC server 20 for a desired service request message or a control request message for controlling the robot 30 using the Session ID assigned by the URC server 20. The URC server 20 performs a corresponding service according to the received service request message or controls the robot 30 according to the received control request message.

More specifically, the robot 30 transmits a packet, which includes corresponding audio data for the voice command of the user, to the URC server 20. The URC server 20 parses the voice command of the received packet, extracts a corresponding Service ID corresponding to the voice command from a database (DB), and assigns the corresponding Service ID to the robot 30. That is, the Service ID is transmitted to the robot 30 corresponding to the Session ID of the packet.

The corresponding robot 30, to which the Service ID is assigned, performs the service corresponding to the Service ID, i.e., one of unmanned security, remote monitoring, speech recognition, video recognition, and movement control, while transmitting a packet for a specified execution mode of the corresponding service to the URC server 20. The robot 30 transmits a packet of the performed result to the URC server 20. The Service ID can set up a plurality of other services that can be performed by the robot 30.

For example, a function of the Service ID is as follows.

After the authorization of the terminals (robot and client) is terminated, when a user requests a specific service (e.g. unmanned security) through the robot 30 in voice, the URC server 20 recognizes the received audio data as a specific service call through a parsing process, and determines if the robot 30 has authority to use the service. As a result, when the corresponding robot 30 is given the authority to use the corresponding service, the URC server 20 assigns the Service ID to the called robot 30. The robot 30, to which the Service ID is assigned, uses the assigned Service ID when using the service.

When the robot 30 transmits a packet to the URC server 20 in order to request an arbitrary service using the assigned Service ID, the URC server 20 parses the Service ID of the header part of the packets transmitted from the robot 30, drives an application for performing the corresponding service, and perform the corresponding service.

The client 10 is assigned the Service ID corresponding to the service for remote monitoring because it is not a moving object like the robot 30. Thereafter, the client 10 receives an operation state of the robot 30, a monitoring image, audio data, etc., by transmitting a packet for the Service ID, and performs monitoring.

More specifically, the client 10 simply monitors the state of the robot 30, etc., rather than communicating with the robot 30 through the URC server 20 to control the robot 30. In this case, the URC server 20 also obtains corresponding information through packet communication with the robot 30 in order to provide information on a state of the robot 30, for example monitoring information including image information, voice information etc., on the state of the robot, to the client 10.

To achieve the service corresponding to the Service ID as described above, embodiments of transceiving the payload message of the packet between the URC server 20 and the robot 30 are sorted into one for speech recognition, one for image recognition, one for authorization, one for movement control, one for control of a client terminal, etc. A message flow between the URC server 20 and the robot 30 for this service will be described in detail with reference to the attached drawings.

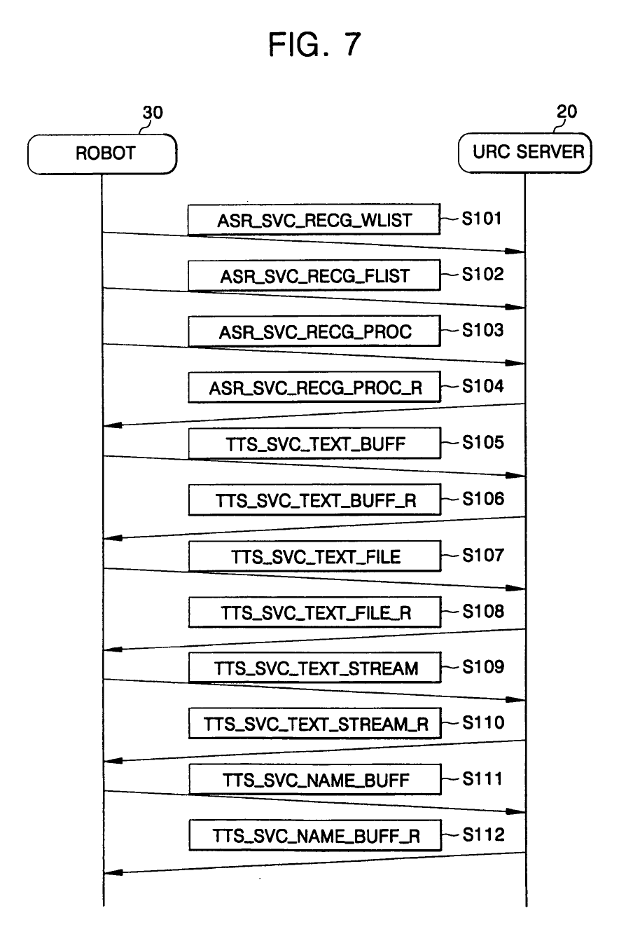

FIG. 7 illustrates a sequence of messages between a robot and a URC server for a speech recognition service of the robot, such as ASR (Automatic Speech Recognition) and TTS (Text To Speech), in a robot control method according to the present invention. As illustrated in FIG. 7, the robot 30 transmits a message, ASR_SVC_RECG_WLST, to the URC server 20 in order to recognize a voice command input by a user in step S101. The ASR_SVC_RECG_WLST message includes a vocabulary list of a user's voice, which is required to recognize the voice command. The URC server 20 transmits a message, ASR_SVC_RECG_FLST, in which a speech recognition vocabulary file name is included, to the robot 30 according to the ASR_SVC_RECG_WLST message received from the robot 30 in step S102. The robot 30 transmits a message, ASR_SVC_RECG_PROC, including the speech recognition data to the URC server 20 in step S103, and then the URC server 20 analyzes the speech recognition data received from the robot 30, and transmits a message, ASR_SVC_RECG_PROC_RESULT, including recognized vocabulary and score information to the robot 30 in step S104.

The robot 30 requests the URC server 20 to synthesize the text using a message, TTS_SVC_TEXT_BUFF in step S105, and the URC server 20 transmits a message, TTS_SVC_TEXT_BUFF_RESULT, according to a result of synthesizing the text to the robot 30 in step S106.

The robot 30 transmits a message, TTS_SVC_TEXT_FILE, to the URC server 20 in order to request the text with a designated file name according to the text synthesis result message received from the URC server 20 in step S107.

The URC server 20 transmits a message, TTS_SVC_TEXT_FILE-RESULT, including a voice file synthesized according to the TTS_SVC_TEXT_FILE message of the robot 30 to the URC server 20 in step S108, and the robot 30 makes a request to synthesize the text transmitted to the URC server 20 with the voice by using a message, TTS_SVC_TEXT_STREAM, in step S109.

Therefore, the URC server 20 transmits the audio data synthesized with the text as well as the ID to the robot 30 using a message, TTS_SVC_TEXT_STREAM_RESULT, by request of the robot 30, in step S110.

The robot 30 requests the URC server 20 to synthesize a person's name using a message, TTS_SVC_NAME_BUFF, in step S11, and the URC server 20 transmits data of the synthesized person's name to the robot 30 through a payload message, TTS_SVC_NAME_BUFF_+RESULT, in step S112.

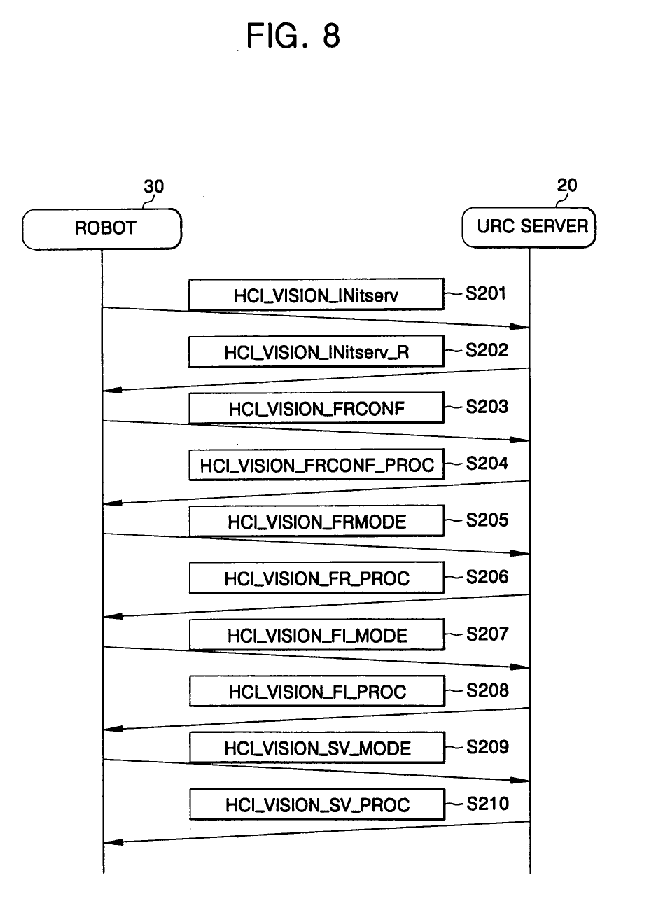

FIG. 8 illustrates a sequence of messages transceived between a robot and a URC server for an image recognition service and a motion detecting (tracing) service in a robot control method according to the present invention. Referring to FIG. 8, in step S201, the robot 30 transmits its session ID, namely robot ID, to the URC server 20 using a message, HCI_VISION_InitServer. The URC server 20 transmits to the robot 30 information on a result of determining whether to give an authority as to whether a service is possible using the corresponding robot ID according to the HCI_VISION_InitServer message of the robot ID received from the robot 30 by using a HCI_VISION_InitServer_RESULT message, in step S202. The robot 30 transmits to the URC server 20 information on whether it is possible to register a user's face according to a registered user ID before a face registration mode is performed, by using a message, HCI_VISION_FRCONF in step S203.

The URC server 20 requests the robot 30 for a face image to be registered when the face can be registered according to the user ID of the robot 30, by using a message, HCI_VISION_FRCONF_PROC in step S204. The robot 30 transmits to the URC server 20 the face image picked up for face recognition by request of the URC server 20 using a message, HCI_VISION_FRMODE, and registers the face image with the URC server 20 in step S205. The URC server 20 transmits to the server 30 a message, HCI_VISION_FR_PROC, notifying that the face image is registered in step S206.

The robot 30 transmits real face data for image recognition to the URC server 20 by using a message, HCI_VISION_FI_MODE in step S207. The URC server 20 transmits to the robot 30 a message, HCI_VISION_FI_PROC, including information on whether it is possible to recognize the face from the face data received from the robot 30 in step S208.

When the robot 30 transmits the video data for unmanned security to the URC server 20 using a message, HCI_VISION_SV_MODE, in step S209, the URC server 20 analyzes the video data transmitted from the robot 30 for the unmanned security, and transmits a message, HCI_VISION_SV_PROC, according to the analyzed result for the unmanned security, to the robot 30 in step S210. Accordingly, the corresponding service is completed.

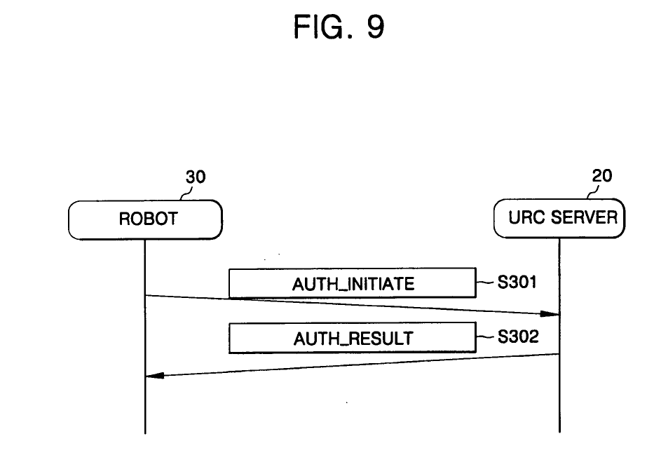

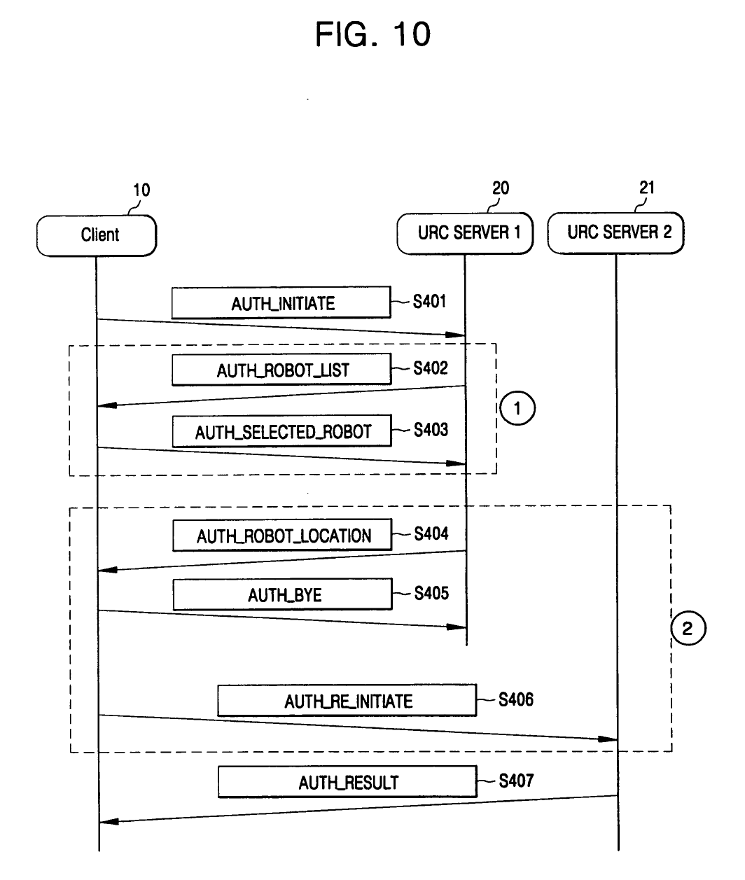

FIG. 9 illustrates a sequence of messages transceived between a robot and a URC server for authorization of the robot in a robot control method according to the present invention, and FIG. 10 illustrates a sequence of authorization messages transceived between a remote robot and a server for remote monitoring of the robot in a robot control method according to the present invention. As illustrated in FIGS. 9 and 10, data for authorization is transmitted when making a request for initial connection, and the authorization is sorted into two types, i.e., one for the robot 30 and one for the client 10.

Referring to FIG. 9, for authorization of the robot 30, the robot 30 transmits a message, AUTH_INITIATE, including information required for the authorization to the URC server 20 in step S301. The URC server 20 analyzes the information that is required for the authorization and transmitted from the robot 30, transmits a message, AUTH-RESULT, including information on the analyzed result, namely authorization result information, and performs the authorization and then other services in step S302.

Referring to FIG. 10, for authorization of the client 10, the client 10 transmits information required for the authorization when making a request for initial connection to the main URC server 20 using a message, AUTH-INITIATE, in step S401, and the main URC server 20 transmits, to the client 10, a message, AUTH_ROBOT_LIST, including information on a list of connectable robots 30 and information on a current state of each robot 30 according to the authorization request of the client 10 in step S402.

The client 10 transmits a message, AUTH-SELECTED_ROBOT, the main URC server 20 in order to perform the authorization of the robot 30 selected by a user from among several robots 30 in step S403. The main URC server 20 transmits, to the client 10, a message, AUTH-ROBOT-LOCATION, including corresponding information on another URC server 21 in order to allocate the URC server 21 to which the robot 30 selected by the user is connected in step S404. This process is for obtaining information on the URC server 21 to which the robot 30 to be controlled is connected, but may be omitted.

In step S405, the client 10 transmits a message, AUTH-BYE, to the main URC server 20 in order to terminate the connection with the main URC server 20, thereby being capable of terminating the connection with the main URC server 20. The client 10 transmits a message, AUTH-RE-INITIATE, that is an authorization request message to the URC server 21 in order to access the URC server 21 to which the robot 30 selected by the user is connected and get a desired service in step S406. Therefore, the URC server 21 transmits a message, AUTH-RESULT, including information on a result of the authorization to the client 10 in step S407, thereby completing the authorization to proceed to the following procedure.

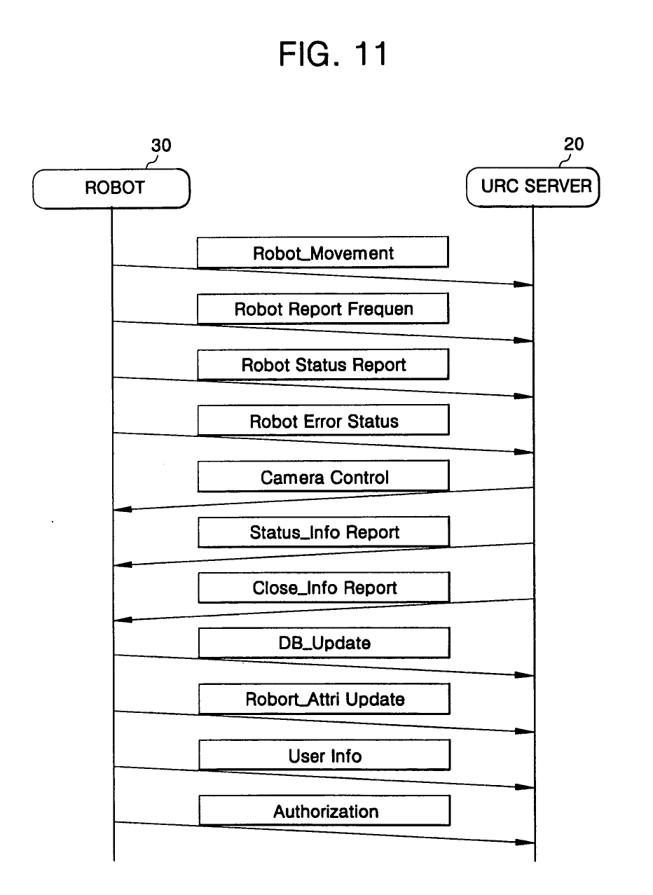

FIG. 11 illustrates types of messages transceived between a robot and a URC server in order to control the robot in a robot control method according to the present invention. Referring to FIG. 11, the messages transmitted from the robot 30 to the URC server 20 may include a Robot_Movement message for making a request for movement control of the robot 30, a Robot_Report Frequency message for deciding a period of checking a status of the robot 30, a Robot Status Report message for reporting information on a current status of the robot 30, and a Robot Error Status message for checking information on an error status of the robot 30.

The messages transmitted from the URC server 20 to the robot 30 may include a Camera Control message for controlling movement of a camera of the robot 30, a Status_Info Report message for notifying the robot 30 of a status of the robot 30 or URC server 20, and a Close_Info Report message for notifying a cause of terminating connection between the robot 30 and the URC server 20. The other messages transmitted from the robot 30 to the URC server 20 may include a DB_Update message for updating data of the URC server 20, a Robot_Attri Update message for updating an attribute DB of the robot, which is transmitted from the robot 30 to the URC server 20, a User Info message for transmitting user IDs and passwords, and an Authorization message for authorizing the robot 30.

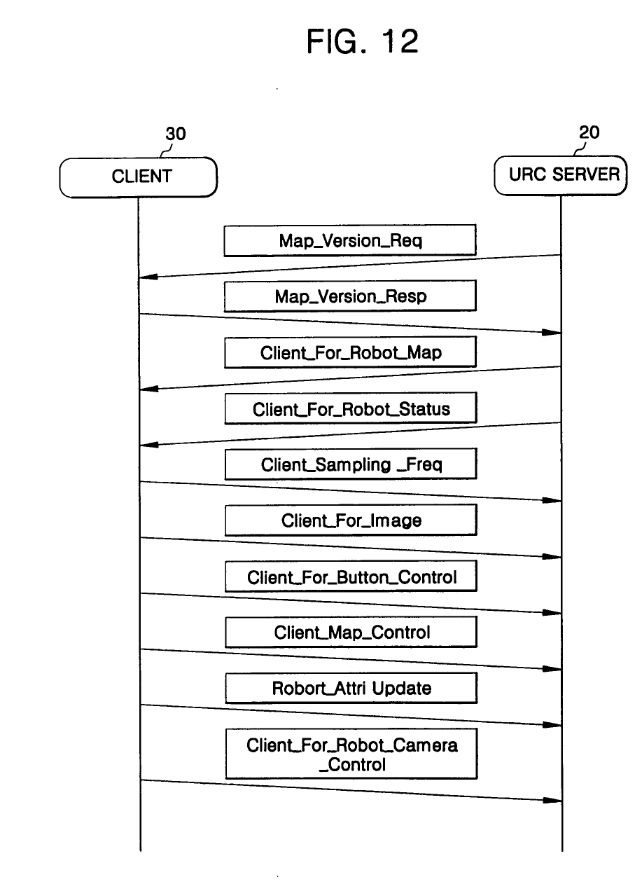

FIG. 12 illustrates types of messages transceived between a remote client and a URC server in order to control the robot through the URC server at the remote client in a robot control method according to the present invention. Referring to FIG. 12, the URC server 20 transmits a Map_Version_Req message for requesting information on a map version from the client 10.

In response to the request from the URC server 20, the client 10 transmits its own map version information to the URC server 20 through a Map_Version_Resp message. In this case, the URC server 20 compares its own map version information with the map version information received from the client 10 through the Map_Version_Resp message, analyzes the comparison result, and transmits information on a matching result of the map version to the client 10 through a Client_For_Image message. Further, the URC server 20 transmits the map version information to the client 10 through the Client_For_Image message when the map versions are not matched.

The URC server 20 first informs the client 10 of a robot status through a Client_For_Robot_Status message. Also, the client 10 transmits to the URC server 20 Client_Sampling-Freq, Client_For_Image, Client_For-Button_Control, Client_Map_Control, and Client_For_Robot_Camera_Control messages, each of which is transmitted in the case of making a request to the URC server 20 for video data as to how often information is received from the URC server 20, when controlling a robot camera to be transmitted to the server, and when making a request for termination.

The present invention as described above suggests a data format for terminals adapted to smoothly interwork between the robot, the server, and the user terminal (client), thereby enabling the robot and the client to smoothly and conveniently monitor the services desired by the robot using the server.

Further, the present invention is adapted to have a message format specialized in the service in order to realize the service. This message format, however, has a drawback that it should be established or added each time in order to develop the service. Further, the added message format is not suitable to realize other applied services, so that it is impossible to reuse the added message format.

Further, as illustrated in FIG. 3, the message format has the Service ID field, and thus the robot, URC server, and client getting the service are allocated the Service ID according a specific service, and realizes the service using the allocated Service ID. As such, in order to get the specific service, different message formats are required for each service.

In addition, in the present invention above, no mechanism for synchronization of performing the service is provided. If the synchronization of performing the service is not correct, a point of time to start and terminate the service may become inaccurate. That is, the service may be provided at the URC server side at an inaccurate time, and thus, it is possible to cause malfunction of the robot.

Further, there is provided no mechanism of coping with an abnormal situation that may occur between the robot and the URC server. More specifically, when the connection of the robot is terminated in a state where the network is unstable, the URC server may fail to detect such a situation, thus recognizing the robot to be continuously connected to the network. Therefore, the user fails to recognize the unstable state of the network, and the URC server fails to take a proper step, for example, of outputting an error message, performing forced termination, etc.

As such, alternative embodiments of the present invention, as will described below, are directed to addressing the problems occurring in the present invention as described above.

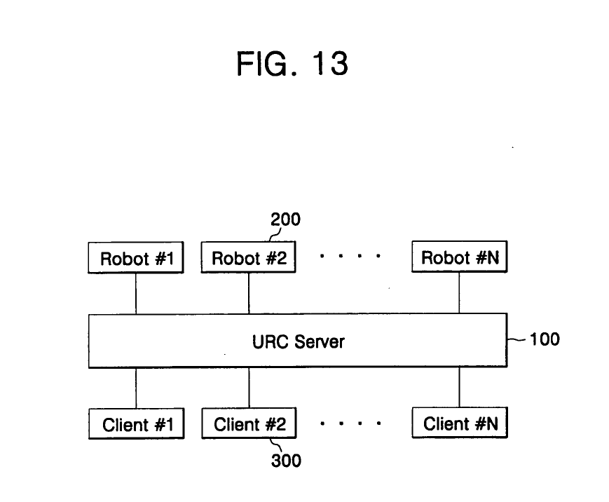

FIG. 13 is a schematic illustrating a connection of a robot control system according to another embodiment of the present invention. As illustrated in FIG. 13, a plurality of robots 200 are connected with a URC server 100 through a network, and a plurality of clients 300 are connected with the URC server 100 through a network at a remote position. The robots 200 obtain voice commands, or status information such as images, etc., input from users or the outside, and transmit the obtained information to the URC server 100.

The URC server 100 processes the voice commands or the image information transmitted from the robots 200, to determine intentions of the users to provide URC services that are intelligent and suitable for the status.

For the URC services, it is possible to provide physical services to the users in addition to the services such as information delivery using mobility.

Further, the remote clients 300 can provide various services using a recognition function and mobility of each robot 200 at the remote position. These services are provided by the URC server 100 as well as service providers at the remote position, such that various business models can be created in the URC infrastructure.

The robots 200 following a URC standard can make use of the various services provided in the URC infrastructure. The numerous robots 200 interworking in the URC infrastructure can provide a market capable of yielding a profit to the service providers.

The URC robots 200 and the remote clients 300 transceive a message in order to communicate with the URC server 100. The message has a format used in a communication protocol between the URC robots 200 or the remote clients 300 and the URC server 100.

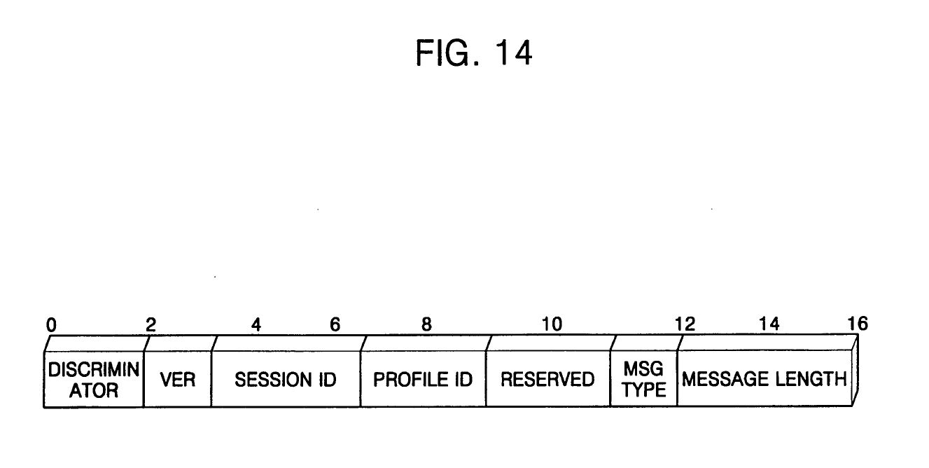

FIG. 14 illustrates a format of a common header of messages transceived between a robot, a URC server, and a client according to an embodiment of the present invention. Referring to FIG. 14, a URC protocol communicates using messages by using a TCP/IP, wherein units of the messages are called URC messages. Framing of the URC message adapts the message configuration of a binary format for the communication efficiency. The URC messages are divided into four types according to use, i.e., URC Request, URC Response, URC Heartbeat, and URC Event. All four message types have a common header format. A type and meaning of data in a header field of the URC common header message are as shown in the following Table 1.

TABLE 1

| FIELD | TYPE | DESCRIPTION |
|---|---|---|
| DISCRIMINATOR | short | URC protocol identifier (e.g. 0x7e7e) |
| VERSION | byte | Version of currently working URC |
| | | protocol (e.g. 0x02) |
| SESSION ID | integer | ID of currently connected session |
| PROFILE ID | short | ID of profile to which message |
| | | belongs (function ID) |
| RESERVED | | Reserved field (2 bytes) |
| MSG TYPE | byte | Type of message |
| MSG LEN | unsigned | Length of message excluding |
| | integer | size of common header |

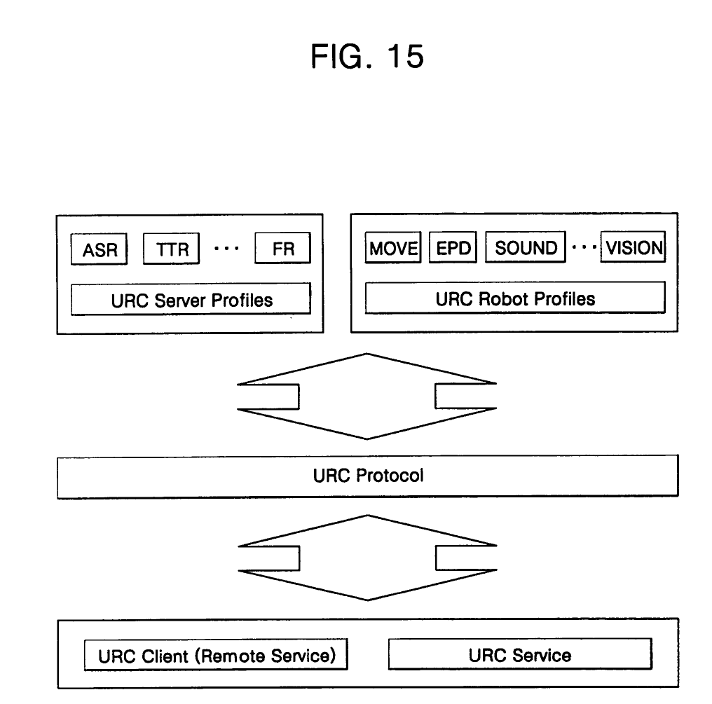

The messages defined in the URC protocol are classified into profiles according to their functions and uses. The profiles provided in the URC protocol are as illustrated in FIG. 15.

FIG. 15 illustrates a URC protocol profile architecture between a robot, a client, and a URC server according to an embodiment of the present invention. Referring to FIG. 15, profiles of the URC server 100 provide various functions required to realize intelligent services such as voice/image recognition, voice synthesis etc., and an interface of enabling the clients 300 to remotely control the robots. Thus, the URC server profiles may include, for example, an authentication profile, a remote interface profile, an event profile, a speech recognition profile, an image recognition profile, and a motion detection profile.

URC common robot profiles as illustrated in FIG. 14 provide a general interface for controlling the robots 200. The URC services may provide physical services using the robot to the users on the basis of the functions provided in the URC common robot profiles. Thus, the URC common robot profiles may include, for example, a move profile, a navigation profile, an EPD (End Point Detection) profile, a sound profile, a motion profile, and an emotion profile.

The URC common robot profiles refer to functions, which robot developers must realize for the URC robots to be provided with the services through the URC infrastructure. The robots realizing the URC common robot profiles can be provided with the same services regardless of their types or performance.

Hereinafter, description will be made about a URC communication protocol operation mechanism between the robot, URC server and client in the present invention.

The URC communication protocol operation mechanism may include a URC message framing mechanism, a URC message encoding mechanism, a URC authentication mechanism, a URC robot ACK (Acknowledge), and an HB (Heartbeat) mechanism.

In the URC message framing mechanism, the URC protocol communicates using messages on the TCP, wherein the units of the messages are called URC messages. Framing of the URC message adapts the message configuration of a binary format for the communication efficiency, and numerous pieces of information contained in the URC messages are represented in the data format of UDR (URC Protocol Data Representation)

In the URC message encoding mechanism, the URC messages are encoded with “little-endian” format, and its Korean encoding uses “KSC-5601.”

In the URC authentication mechanism, every URC robot and URC client having access to the URC infrastructure pass through authentication process to be identified into users and robots 200 and then grant themselves of the necessary rights. Pre-registered ROBOT ID identifies the URC robots 200, and the URC clients 300 authenticate themselves by performing authentication based on a user ID and password.

In the URC robot ACK called an event notification and acknowledge, when the events such as voice commands and movements occur in the URC environment, the URC robots 200 must be able to asynchronously notify the URC server 100 of this information. Using such asynchronous events, the URC server 100 perceives user's intention and status, and then produces the adequate services suitable for the intention and status.

Furthermore, because most functions provided by the URC robots 200 require somewhat many time-consuming works from the start to end of the function, the URC server 100 must be acknowledged with the start and end of the work in the form of events to enable the functions of URC robots to be synchronous with other functions. The URC server 100 performs the synchronization required to perform the services through the ACK.

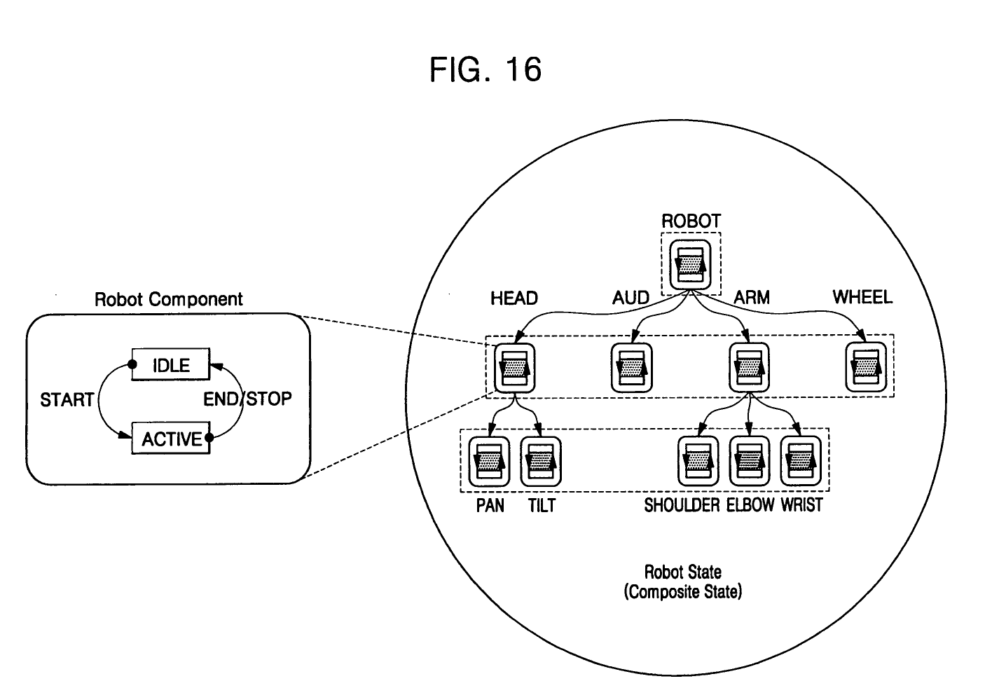

The URC robot ACK operation is illustrated in FIG. 16. As illustrated in FIG. 16, because each function of the URC robot 200 can be defined by each component, each component performs its operations in a state machine, for example, constituents of the URC robot 200 as illustrated in FIG. 16, and should notify the URC server 100 of the corresponding event at a point of time when the state of the URC robot 200 is in transition.

That is, because the functions of each URC robot 200 can be defined by each component, each component of the URC robot performs its operations in a state machine, and must notify the corresponding event at a point of time when the state is in transition.

In the URC protocol, the state of each component of the URC robot 200 is divided into two types, i.e., “IDLE” and “ACTIVE.” When each state is transited into another state, the URC server 10 should be notified with the event of “START,” “END,” or “STOP.” Therefore, the URC server 100 can easily detect a current operation state of the robot on the basis of the event message transmitted from the URC robot 200.

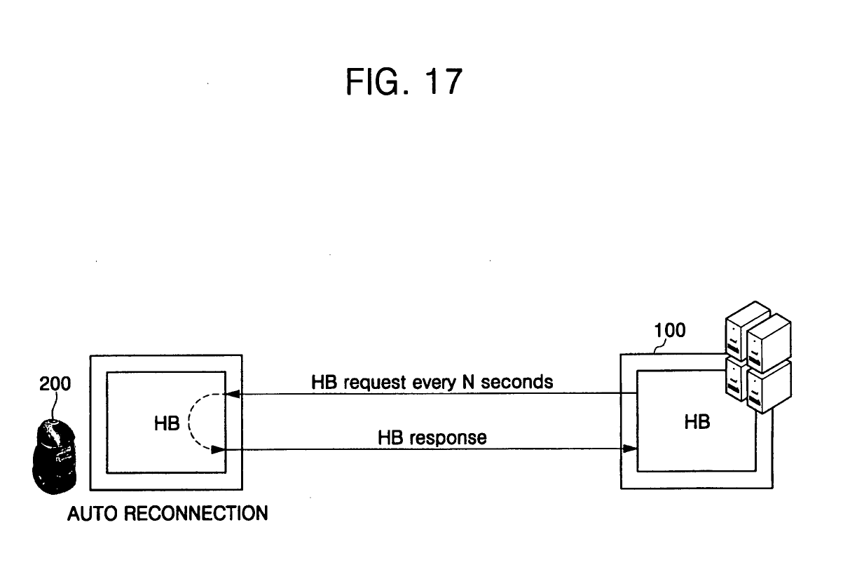

In the URC HB mechanism, basically, the URC robots 200 are driven and simultaneously connected to the URC server 100. The URC robots 200 keep the connection until they stop driving. Therefore, for a disconnection caused by abnormal network environments while the services are performed, it is important to swiftly detect the abnormal situation and to take a proper step. In order to continue to monitor if a normal network connection is kept between the URC server 100 and the URC robots 200, the URC protocol defines an HB (Heartbeat) protocol between the URC robot 200 and the URC server 100, thereby managing the abnormal situation caused by such network environments. Accordingly, detecting the connection between the URC robots 200 and the URC server 100 in the abnormal network environments is illustrated in FIG. 17.

FIG. 17 illustrates a method of checking a connection between the URC robots and the URC server. As illustrated in FIG. 17, the URC server 100 transmits a Heartbeat request message to the URC robots 200 by periods (e.g., at an interval of N second(s)). Each URC robot 200 transmits a Heartbeat response message to the URC server 100 according to the Heartbeat request message transmitted from the URC server 100. Therefore, the URC server 100 can check the network connection with the URC robots 200.

In spite of the transmission of the Heartbeat request message, the URC server 100 may not receive the Heartbeat response message within a predetermined period. In this case, the URC server 100 determines that the network connection is abnormal. However, when the Heartbeat response message is received within a predetermined period, the URC server 100 determines that the connection with the URC robots 200 is normal. Therefore, when determining that the network connection is abnormal, the URC server 100 attempts reconnection with the URC robots 200, thereby continuously controlling the URC robots 200.

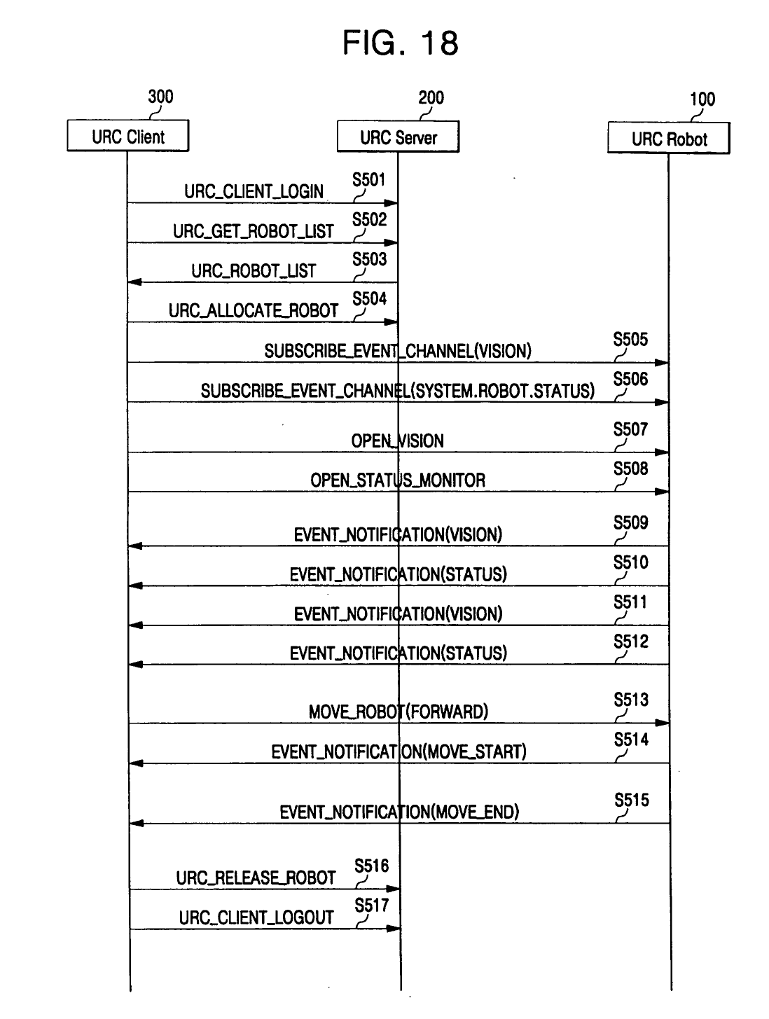

The method of controlling the robot through the URC server at the remote client using the mechanisms and URC protocol messages as mentioned above will be described with reference to FIG. 18.

FIG. 18 illustrates a sequence of messages transceived to remotely control a robot at a client according to an embodiment of the present invention. Referring to FIG. 18, the URC robot 200 starts to connect to the URC server 100, and transmits to the URC server 100 a voice command or status information such as current image information that it obtains. The URC robot 200 receives a control command from the URC server 100, and performs action prescribed in the URC protocol.

The remote client 300 is connected to the URC server 100 at a remote position, selects the URC robot 200 which it intends to control, and obtains necessary information from the URC robot 200 or controls the URC robot 200 according to the logic of a service that it intends to realize.

In the case of remote control and monitoring service, the remote client 300 makes a request to transmit the image information and state information to the URC robot 200, such that it can check an image and state of the URC robot 200. Further, the remote client 300 can control the URC robot 200. For example, the remote client 300 can move the URC robot 200 at a remote position through a robot control command, or generate a sound from the URC robot 200.

An action flow of controlling or monitoring the robot at the client will be sequentially described with reference to FIG. 18. Referring to FIG. 18, the remote URC client 300 transmits a URC_CLIENT_LOGIN message to the URC server 100 in order to remotely control the URC robot 200 or provide a monitoring service of the URC robot 200, and is connected to the URC server 100 in step S501. The URC client 300 gets authentication from the URC server 100. The authentication procedure of the client has been already described in the above, and thus its detailed description will not be made again.

After the authentication is completed, the URC client 300 transmits a URC_GET_ROBOT_LIST message to the URC server 100 in order to make a request for information on a list of the URC robots 200 connected to the URC server 100 in step S502. The URC server 100 transmits a URC_ROBOT_LIST message containing the robot list information to the URC client 300 by request of the UC client 300 in step S503.

The URC client 300 allocates a robot to be controlled according to the robot list information transmitted from the URC server 100, and transmits a URC_ALLOCATE_ROBOT message to the URC server 100 in order to make a request for information on robot allocation and use authority of the corresponding robot in step S504.

When the user authority for robot control is granted by the URC server 100, the URC client 300 transmits SUBSCRIBE_EVENT_CHANNEL (VISION, SYSTEM, ROBOT, STATUS) messages to the corresponding robot 200 in order to subscribe to each corresponding event channel, so that it can monitor the status and image information required to control or remotely monitor the corresponding robot 200 in steps S505 and S506. The URC server 100 serves as an interface for the corresponding message, which is transmitted from the URC client 300, to the corresponding robot 200 allocated by the URC client 300.

Further, the URC client 300 transmits an OPEN_VISION message and an OPEN_STATUS_MONITOR message to the corresponding robot 200 through the URC server 100 in order to make a request to the corresponding robot 200 for the status and image information after it subscribes to a desired event channel in steps S507 and S508.

The URC robot 200 transmits EVENT_NOTIFICATION (VISION, STATUS) messages, that include the information of the image that it picks up, and the state information, to the URC client 300 by periods by request of the URC client 300 in steps S509 to S512.

The URC client 300 transmits a MOVE_ROBOT (FORWARD) message to the robot 200 in order to control movement of the robot 200 using the image and state information transmitted from the robot 200 in step S513.

The URC robot 200 performs corresponding movement by request of the URC client 300. In this case, the URC robot 200 transmits EVENT_NOTIFICATION (MOVE_START) and EVENT_NOTIFICATION (MOVE_END) messages to the URC client 300 in order to exactly notify the start and end of the movement, so that the URC client 300 easily checks a movement state of the robot 200 to carry out service synchronization in steps S514 and S515.

With the above-mentioned method, the URC client 300 can remotely control the URC robot 200 in real time using the image and state information transmitted from the robot 200.

Thereafter, if the service is terminated, namely when the remote control of the robot 200 is terminated at the URC client 300, the URC client 300 transmits a URC_RELEASE_ROBOT message to the URC server 100 in order to release the allocation of the remotely controlled robot 200 in step S516. Further, the URC client 300 transmits a URC_CLIENT_LOGOUT message to the URC server 100 in order to terminate the connection of the URC server 100 in step S517. Accordingly, all the services are terminated.

As described above, in the present invention, the specialized message format is improved to the protocol of the common profile type, so that the service provider can perform service logic-oriented development by utilizing protocol layers. Therefore, the common interface and infrastructure are provided without addition of a new message, so that the more convenient service can be added. Further, the interface capable of configuring the service logic is provided at a remote position by utilizing the profiles, so that the provider can easily add the service.

Further, in order to provide service performing synchronization, new formats of message primitives, Request and Response, that are provided, are improved, and Event messages are added. More specifically, explicit Acknowledges are sent using the Event messages with respect to the services that are being performed on all the robots, so that generation of errors is reduced, and the service logic is configured with more ease.

Also, the URC HB message is added, and thus the abnormal status of the robot or server is checked, so that it is possible to take a resulting step. This makes it possible to check the status between the user and the robot server in a more efficient way.

The network-based robots comply with the protocol proposed in the present invention, so that it is possible to provide the user with the services that are intelligent and suitable for circumstances by utilizing various functions provided in the URC infrastructure.

Further, the URC client can provide various services utilizing a sensing function and mobility of the robot. This enables the services to be provided by the URC server alone, as well as the service providers at a remote position, so that various business models can be created in the URC infrastructure.

Consequently, the robots complying with the URC protocol can make use of various services provided in the URC infrastructure. Many robots interworking in the URC infrastructure can provide a market capable of yielding a profit to the service providers, so that it is possible to greatly contribute to distribution of the intelligent robot services.

The present invention as set forth above suggests the data format for the protocol that makes it possible to smoothly interwork between the robot, server, and user client, thereby securing effective compatibility even between numerous robots and clients to promote widespread use.

Furthermore, in order to provide synchronization of performing the service, Event messages are added. Explicit Acknowledges are sent using the Event messages with respect to the services that are being performed on all the robots, so that generation of errors is reduced, and the service logic is configured with more ease.

In addition, there is provided a mechanism of coping with abnormal status that may occur between the URC robots and the URC server. More specifically, the URC HB message is added, and thus the abnormal status of the robot or server is checked, so that the corresponding step can be easily taken. This makes it possible to check the status between the user and the robot server in a more efficient way.

Further, the network-based robots comply with the protocol proposed in the present invention, so that it is possible to provide the user with the services that are intelligent and suitable for circumstances by utilizing various functions provided in the URC infrastructure.

Further, the URC client can provide various services utilizing a sensing function and mobility of the robot. This enables the services to be provided by the URC server alone, as well as the service providers at a remote position, so that various business models can be created in the URC infrastructure.

Consequently, the robots complying with the URC protocol can make use of various services provided in the URC infrastructure. Many robots interworking in the URC infrastructure can provide a market capable of yielding a profit to the service providers, so that it is possible to greatly contribute to distribution of the intelligent robot services.

While the present invention has been described with reference to exemplary embodiments thereof, it will be understood by those skilled in the art that various changes in form and detail may be made therein without departing from the scope of the present invention as defined by the following claims.

What is claimed is:

1. A data format for transmitting data between a terminal and a server, the data format comprising:
a Protocol Discriminator field for permitting interfacing between the terminal and the server;
a Session identification (ID) field for setting up an ID to identify the terminal;
a Data Direction field for setting up a direction to transmit the data between the terminal and the server;
a Data Type field for representatively defining at least one of the format and content of the data;
a Service ID field for determining if a message service to be performed by at least one of the terminal and the server is used, and setting up an ID to identify the determination; and
a Payload field for setting up the data defined in the Data Type field and an available service determined in the Service ID field, and assigning a message to enable the terminal and the server to use the service.

2. The data format according to claim 1, wherein the message of the Payload field is divided into messages for video, audio, and movement, the message for video and the message audio having file number and size, and video data, and the message for movement having robot movement, robot status control, robot status report, robot error status, and command type of camera control according to a control form to control the movement.

3. The data format according to claim 2, wherein:
the file number is formed of a client type, a client ID, and a file generation sequence;
the robot movement is a message for controlling movement and has x-axis movement distance and y-axis movement distance of the terminal, a position angle of the terminal, and a camera angle to control the movement;
the robot status control has a status report and a reporting period of the terminal in order to confirm a current status of the terminal in real time;
the robot status report is a message indicating a service result of the terminal and has messages of status information such as an unmanned alarm set status according to the robot movement status, a movement status of the terminal, a monitoring status, an abnormal status, an identity confirmation status, an alarm status, position information of the terminal, and action completion information;
the robot error status is a message indicating an operation condition of the terminal to determine if at least one terminal is abnormal; and
the camera control is a message related with video transmission.

4. The data format according to claim 2, wherein the Payload field further comprises:
a Client Type field;
a Client ID field;
a User ID field;
an Authorization code field; and
a Message Type Field,
provide ASR (Automatic Speech Recognition) data for recognizing voice, TTS (Text To Speech) data to output voice, FR (Face Recognition)/MD (Motion Detection) data for identifying a face and detecting motion, Authorization data for authorization, Movement data, and VoIP data.

5. The data format according to claim 4, wherein:
the Client Type field indicates a kind of terminal corresponding to the directionality information of the Data Direction field;
the Client ID field sets up an ID corresponding to at least one terminal and is used to identify a terminal corresponding to the directionality information of the Data Direction field;
the User ID field sets up an ID with which the server recognizes the at least one terminal, the ID having a message corresponding to a number of registered users; and
the Authorization Code field provides authorization numbers of each of the at least one terminals.

6. The data format according to claim 4, wherein the Message Type field provides procedures for connection initialization between the terminal and the server, response, synchronization, authorization, and data transmission, and
wherein the message transmitted between the terminal and the server includes a message for a first message group to connect the terminal to the server, a second message group to make an authorization between the terminal and the server, a message for continuity of the first and second message groups, a Payload message to be transmitted between the authorized terminal and server, and a termination message.

7. The data format according to claim 6, wherein the first message group comprises:
a Request Message;
a Acknowledgement Response Message; and
Error Acknowledgement Response Message,
the second message group comprises:
an Authorization Message;
a Positive Authorization Message; and
Negative Authorization Message, the message for continuity is Synchronization Message,
wherein the Payload message is a Data Message, and the termination message is a Close Report Message.

8. The data format according to claim 1, wherein the terminal includes at least one of at least one robot and at least one client terminal.

9. The data format according to claim 1, further comprising a Protocol Version field for indicating an update status of the data format.

10. A communication control system utilizing a specialized data format on a basis of wired and wireless communication, the system comprising:
a terminal for performing at least one service for video, audio, and movement according to Payload contents of the specialized data format; and
a server for recognizing user commands through the terminal to transmit and receive the specialized data format to and from the terminal according to corresponding protocol, and controlling to perform the service with the data format,
wherein the specialized data format includes a Protocol Discriminator field for permitting interfacing between the terminal and the server, a Session identification (ID) field for setting up an ID to identify the terminal, a Data Direction field for setting up a direction to transmit the data between the terminal and the server, a Data Type field for defining at least one of the format and content of the data, a Service ID field for determining if a message service to be performed by at least one of the terminal and the server is used, and setting up an ID to identify the determination, and a Payload field for setting up the data defined in the Data Type field and an available service determined in the Service ID field, and assigning a message to enable the terminal and the server to use the service.

11. The communication control system according to claim 10, wherein the terminal comprises at least one of at least one robot and at least one client terminal.

12. The communication control system according to claim 11, wherein the at least one robot processes the voice message from a user into a data format to operate by itself, provides the server with the data format, and performs a corresponding service message to inform the user of the result, and
the client terminal processes the user's desired service message into the data format in order to control the robot, transmits the data format to the server, and receives the service result of the robot from the server to inform the user of the result.

13. The communication control system according to claim 12, wherein the message is a Payload message including a message for authorization number and procedure, a video recognition message, a speech recognition message, and a control message for movement, and provides the user with unmanned security and remote monitoring services.

14. A method of transmitting a terminal data format between at least one terminal and a server using a corresponding protocol on a basis of wired and wireless communication, the method comprising the steps of:
confirming an authorization between the terminal and the server using the terminal data format according to an authorization procedure;
assigning a Session identification (ID) to identify each of the at least terminal using the terminal data format after the authorization;
inputting a voice command of a user to a corresponding terminal assigned the Session ID;
transmitting a Payload message of the terminal data format having voice data to the server;
analyzing the Payload message in order to call back to the Service ID; and
transmitting, by the corresponding terminal performing an operation according to the Service ID, the result to the server as a Payload message of the packet.

15. The method according to claim 14, wherein the service corresponding to the Service ID performs unmanned security, remote monitoring, speech recognition, video recognition, and movement control.

16. The method according to claim 14, wherein the authorization procedure comprises the steps of:
attempting access, by the terminal, to the server by sequentially performing Request Message, Acknowledge response Message, and Error Acknowledge response Message of Message Type corresponding to an internal field of the Payload message of the data format; and
assigning an authorization number according to an authorization request of the terminal by sequentially performing Authorization Message, Positive Authorization Message, and Negative Authorization Message of the Message Type after making the connection.

17. The method according to claim 16, wherein, when the terminals include a plurality of terminals, the step of assigning the authorization number further comprises the steps of:
receiving a list of the plurality of terminals; and
transmitting an authorization request message to a desired corresponding terminal using a Select Message.

18. The method according to claim 14, wherein the terminal is formed of at least one of at least one robot and at least one client terminal.

19. A data format for a terminal, in which the data format is transceived between a robot, a server, and a client in order to control the robot, the data format comprising:
a Protocol Discriminator field including information on a protocol identifier (ID) in order to permit interfacing between the robot, the server, and the client;
a Session ID field including unique ID information for identifying a currently connected session;
a Profile ID field including information for identifying a profile performed by any one of the robot, the server, and the client;
an MSG Type field including information on types of messages transceived between the robot, the server, and the client; and
a Payload field including the message for performing a service for a corresponding function according to data defined in the MSG Type field and the profile information included in the Profile ID field.

20. The data format according to claim 19, wherein the profile of the server comprises at least one of:
an authentication profile for authenticating the robot and the client;
a remote control profile for providing an interface that enables the client to remotely control the robot;
an event profile for enabling one of the server and the client to control an event of the robot;
a speech recognition profile for recognizing a voice of a voice command received from the robot;
a speech synthesis profile for synthesizing speech recognition data with text data;
an image recognition profile for recognizing image information transmitted from the robot; and
a motion detection profile for detecting motion of the robot.

21. The data format according to claim 19, wherein the profile of the robot comprises at least one of:
a move profile for robot position movement;
a navigation profile;
a speech detection profile of a voice command;
a sound profile for outputting data to voice synthesis provided from the server;
a motion profile for controlling movement of the robot; and
an emotion profile for performing an emotion expression function of the robot.

22. The data format according to claim 21, wherein the profile of the robot further comprises an event provision profile for providing information on a movement transition event to one of the server and client, when a movement control message of the robot is received from one of the server and client and a movement state of each component of the robot is in transition.

23. The data format according to claim 22, wherein the movement transition event divides the movement state of each component of the robot into IDLE and ACTIVE states, and divides events of START and END when one of the robots states transitions to the other.

24. The data format according to claim 20, wherein the profile of the server further comprises a Heartbeat request profile for transmitting a Heartbeat request message by periods in order to detect a network connection status of the robot.

25. The data format according to claim 21, wherein the profile of the robot further comprises a Heartbeat response profile of transmitting a Heartbeat response message to the server according to a Heartbeat request message transmitted from the server by periods in order to detect a network connection status of the robot.

26. A communication control system comprising:
a robot for performing at least one of video, audio, and movement services according to content of Payload of a previously set data format;
a server for recognizing a command of a user through the robot, for transceiving the data format with respect to the robot according to a corresponding protocol, and for performing the service with the data format; and
a client for performing a remote control and monitoring service of the robot through the server at a remote position.

27. The communication control system according to claim 26, wherein the robot provides information on a movement transition event to one of the server and client when a control message for controlling each component included in the robot is received from one of the server and client to drive the corresponding component and a movement state of the corresponding component is in transition.

28. The communication control system according to claim 27, wherein the movement transition event information divides the movement state of each component of the robot into IDLE and ACTIVE states, and includes information on events of START and END, when one of the states transitions to the other.

29. The communication control system according to claim 26, wherein the server transmits a Heartbeat request message by periods in order to detect a network connection status of the robot, and detects the network connection status of the robot depending on if a Heartbeat response message is received from the robot.

30. The communication control system according to claim 29, wherein the robot transmits the Heartbeat response message to the server according to the Heartbeat request message transmitted from the server by periods.

31. The communication control system according to claim 26, wherein the server performs authentication of the client in order to enable the client to remotely control the robot, provides information on a list of the robots connected therewith to the client, and provides an interface between the robot and the client when the robot to be controlled is allocated by the client.

32. The communication control system according to claim 26, wherein the data format set previously between the robot, the server, and the client comprises:
a Protocol Discriminator field including information on a protocol identifier (ID) in order to permit interfacing between the robot, the server, and the client;
a Session ID field including unique information for identifying currently connected sessions;
a Profile ID field including information for identifying a profile performed by any one of the robot, the server, and the client and the other profiles performed by the others;
an MSG Type field including information on types of messages transceived between the robot, the server, and the client; and
a Payload field including the message for performing a service for a corresponding function according to data defined in the MSG Type field and the profile information included in the Profile ID field.

33. The communication control system according to claim 32, wherein the profile of the server comprises at least one of:
an authentication profile for performing authentication of the robot and the client;
a remote control profile for providing an interface to enable the client to remotely control the robot;
an event profile for enabling one of the server and the client to control an event of the robot;
a speech recognition profile for recognizing a voice of a voice command received from the robot;
a speech synthesis profile for synthesizing speech recognition data with text data;
an image recognition profile for recognizing image information transmitted from the robot; and
a motion detection profile for detecting movement of the robot.

34. The communication control system according to claim 32, wherein the profile of the robot comprises at least one of:
a move profile for robot position movement;
a navigation profile;
a speech detection profile for a voice command;
a sound profile for outputting data to voice synthesis provided from the server;
a motion profile for controlling movement of the robot; and
an emotion profile for performing an emotion expression function of the robot.

35. A method of controlling at least one robot using at least one remote client in a communication control system having the at least one remote client, the at least one robot, and a server providing an interface between the at least one remote client and the at least one robot, the method comprising the steps of:
providing, by the at least one remote client, connection to the server in order to perform a service for remote control;
monitoring any of the at least one robots;
requesting authentication and information on a list of the at least one robot connected to the server;
performing, by the server, the authentication of the at least one remote client;
transmitting the list information of the at least one robot connected with the server to the at least one remote client;
selecting, by the at least one remote client, the at least one robot to be controlled using the robot list information transmitted from the server;
transmitting the corresponding information to the server;
setting, by the server, an interface between the robot selected by the at least one remote client and the at least one remote client in order to transceive a message for the robot remote control; and
monitoring service.

36. The method according to claim 35, wherein when the interface is set between the at least one remote client and the at least one robot selected by the at least one client, the method further comprising the steps of:
subscribing to, by the at least one remote client, various service channels for controlling the robot through the server;
making, by the at least one remote client, a request to the robot for information on an image picked up by the robot and information on a status of the robot through the server after subscribing to the channels;
transmitting a control message for controlling an arbitrary function of the robot according to the image information and the status information that are transmitted from the robot by periods;
performing, by the robot, a corresponding function according to the control message transmitted from the at least one remote client through the server;
transmitting information on events of a start time point and end time point of the corresponding function to the client through the server;
transmitting, by the at least one remote client, a message of requesting to terminate connection with the robot to the server when the robot remote control and monitoring service is finished; and
logging out the connection with the robot.

37. The method according to claim 36, further comprising the steps of:
transmitting, by the server, a Heartbeat request message to the robot by periods in order to check a network connection status of the robot;
transmitting, by the robot, a Heartbeat response message according to the Heartbeat request message transmitted from the server; and
notifying information on the network connection status to the server.
